(19) United States
(12) Patent Application Publication
(10) Pub. No.: US 2025/0110352 A1
(43) Pub. Date: Apr. 3, 2025

(54) TORIC CONTACT LENSES EMPLOYING STABILIZATION MECHANISM TO MINIMIZE EFFECT OF ASYMMETRIC EYELID BIAS IN SETTLED ORIENTATION, AND RELATED METHODS OF DESIGN

(71) Applicant: Johnson & Johnson Vision Care, Inc., Jacksonville, FL (US)

(72) Inventors: Gary Richardson, Jacksonville, FL (US); Pierre-yves Gerligand, Jacksonville, FL (US)

(21) Appl. No.: 18/374,779

(22) Filed: Sep. 29, 2023

(51) Int. Cl. G02C 7/04

(52) U.S. Cl. CPC G02C 7/048

(57) ABSTRACT

Toric contact lenses employing a stabilization mechanism to minimize the effect of asymmetric eyelid bias in settled orientation of the toric contact lens, and related methods of design. The toric contact lens includes stabilization zones that are each disposed horizontal sides of the lens periphery of the contact lens between its central optic zone and the lens edge. To minimize the effect of asymmetric bias of an eyelid of a patient wearer on the alignment of the toric contact lens to the principal meridians of the eye, the portion of the contour lines in the stabilization zones that are configured to intersect with an upper eyelid margin in wear are oriented to a target upper eyelid margin shape of a target upper eyelid of an average patient wearer. In this manner, the stabilization zone of the toric contact lens is more desensitized to any asymmetric shape of the wearer's eyelid.

### FIELD OF THE DISCLOSURE

The present disclosure relates to the field of ophthalmic lenses for use with astigmatic patients. More specifically, the present disclosure is related to toric contact lenses that include a stabilization mechanism to keep the contact lens relatively stable in the eye to maintain alignment of corrective powers in the lens along the two principal meridians.

### BACKGROUND

Common conditions that lead to reduced visual acuity include myopia (i.e., nearsightedness) and hyperopia (i.e., farsightedness) for which corrective lenses in the form of spectacles, rigid, or soft contact lenses are prescribed. These conditions are generally described as the imbalance between the length of the eye and the focus of the optical elements of the eye. Myopic eyes focus light in front of the retinal plane, and hyperopic eyes focus light behind the retinal plane. Myopia typically develops because the axial length of the eye grows to be longer than the focal length of the optical components of the eye; that is, the eye grows too long. Hyperopia typically develops because the axial length of the eye is too short compared with the focal length of the optical components of the eye. Patients with these conditions can have their vision corrected with spherical contact lenses having the appropriate lens spherical power.

Astigmatism is an optical or refractive defect in which an individual's vision is blurred due to the eye's inability to focus a point object into a focused image on the retina. Astigmatism is caused by a non-rotationally symmetric curvature of the refracting surfaces of the eye (including the cornea and crystalline lens). For example, FIG. 1A illustrates an astigmatic eye 100 that includes a cornea 102 that is curved more steeply in one direction than another such that the refracting surfaces of the cornea 102 are not rotationally symmetric. In other words, one or more of the refracting surfaces of the cornea 102 are more curved or steeper on the principal meridian relative to the other orthogonal principal meridian thereby having a different amount of optical power along the different meridians and a wavefront aberration. This causes an image 104 to be stretched out into two-line foci 106 rather than focused to a single point. A non-astigmatic eye 108 shown in FIG. 1B has a cornea 110 that has a rotationally symmetric refracting surface, thereby causing an image 112 to be focused to a single point 114.

Corneal astigmatism may be corrected using a hard or rigid gas-permeable contact lens. In this case, a fluid or tear lens may exist between the posterior surface of the rigid contact lens and the cornea. This fluid or tear lens follows or assumes the shape of the back surface of the contact lens. Since the index of refraction of the fluid or tear lens is nearly a match for the cornea, the corneal toricity is optically neutralized or reduced. In these cases, a toric lens will generally not be required. However, rigid gas-permeable contact lenses and hard contact lenses are generally less comfortable than soft or hydrogel contact lenses. Since soft or hydrogel contact lenses wrap around the cornea, a fluid lens is generally not found, and the tear fluid more closely resembles a thin film. In this case, a toric lens design is required.

A toric lens is an optical element having two different powers in two orientations that are perpendicular to one another. Essentially, a toric lens has one power, spherical, for correcting myopia or hyperopia, and another power, cylinder, for correcting astigmatism built into a single lens. These powers are created with curvatures oriented at different angles which are maintained relative to the eye. Toric lenses may be utilized in eyeglasses, intraocular lenses, and contact lenses. The toric lenses used in eyeglasses and intraocular lenses are held fixed relative to the eye by either the spectacle frame or haptics, thereby always providing optimal vision correction. Toric contact lenses, however, may tend to rotate on the eye, thereby temporarily providing sub-optimal vision correction. Accordingly, toric contact lenses also include a mechanism to keep the contact lens relatively stable on the eye when the wearer blinks or looks around. Toric contact lenses need to accomplish two things, namely, to rotate to the proper orientation in the eye on insertion and to maintain that orientation through the wear period.

Maintenance of the on-eye orientation of toric contact lenses is typically accomplished by mechanical means. For example, “prism stabilization,” including decentering or tilting of the contact lens' front surface relative to the back surface, thickening of the inferior contact lens periphery, forming depressions or elevations on the contact lens surface, and truncating the contact lens edge are all methods that have been utilized.

Additionally, “static stabilization” has been used in which the contact lens is stabilized by the use of a “stabilization” zone. A stabilization zone is an area of the contact lens periphery having a thickness profile in which the thickness is increased or reduced, as the case may be. Typically, the stabilization zone is located in the contact lens periphery with symmetry about the vertical and/or horizontal axes. For example, a stabilization zone may include active zones that are points of stabilization that include a thickness gradient and centrally positioned on either side of the optic zone and centered along the 0-180-degree axis of the contact lens, as shown for example in U.S. Pat. No. 11,281,024. In another example, a single thick stabilization zone positioned at the bottom of the contact lens provides a similar weight effect, like that of prism stabilization, but also incorporates a region of increasing thickness from top to bottom in order to utilize upper eyelid forces to stabilize the contact lens may be designed. It is important to note that the older technical literature utilized the term “dynamic stabilization” for what is meant here as static stabilization. The terms static and dynamic stabilization may be utilized interchangeably.

Thus, when designing the shape of a toric contact lens with a stabilization zone(s), the thickness profile of the stabilization zone(s) and its active zones can be based on the eyelid(s) of the patient coming into contact with the stabilization zone to force the rotational orientation and stabilization of the toric contact lens. This is shown in the model eye 200 FIG. 2. As shown in FIG. 2, the eye 200 of a patient is fitted with a toric contact lens 202. An upper eyelid 204 and lower eyelid 206 of the eye 202, and more specifically their respective upper and lower eyelid margins 208, 210 will come into contact with the contact lens 202 as a function of movement of the upper and lower eyelids 204, 206. The eyelids 204, 206 will encounter areas of increasing thickness in stabilization zones 212, 214 (e.g., in its active zones) of the toric contact lens 202 according to the gradient of the stabilization zones 212, 214 as a function of the upper and/or lower eyelids 204, 206 moving or blinking. Resistance between the eyelids 204, 206 to the toric contact lens 202 increases as the eyelids 204, 206 move (shown in the directions of arrows in FIG. 2) from between different active zones of the stabilization zones 212, 214 of reduced thickness to increased thickness in the toric contact lens 202. The pressure imbalance between the lens 202 and the active zones in the stabilization zones 212, 214 on the periphery areas of the lens 202 causes the lens 202 to orient itself relative to the eyelid margins 208, 210 of the eye 200 in which the lens 202 is presented. The toric contact lens 202 orientation will track (i.e., register to) the shape of the eyelid margins 208, 210 and follow its shape because the rotational alignment of the toric contact lens 202 is driven based on the eyelid 204, 206 shape through the stabilization zones 212, 214.

However, the shape of eyelids 204, 206 and their eyelid margins 208, 210 can vary greatly between different patients. For example, some eyelids slope down nasally while others slope down temporally. In either of these cases, the eyelid margin is asymmetric to the eye and its principal meridians if the eye is astigmatic. If an eyelid margin is asymmetric to its eye, a toric contact lens with a stabilization zone(s) presented to such an eye will also have an asymmetric biased tilt/rotation from a symmetrical alignment on the eye. This causes the corrective powers in the toric contact lens to be misaligned to one or both of the principal meridians of the eye. It is important in a toric contact lens for the corrective powers for both principal meridians of the eye to be aligned with the principal meridians of the eye for correcting astigmatic vision.

An example of a toric contact lens that includes a stabilization zone to provide rotational stabilization in an eye is found in U.S. Pat. No. 11,327,341 B2 to Straker. Straker discloses a toric contact lens that includes a stabilization zone with contour lines of the active zones designed to be parallel to an eyelid margin, such that the thickness gradient of the stabilization zone is substantially orthogonal to the eyelid margin.

### SUMMARY OF THE DISCLOSURE

Aspects disclosed herein include toric contact lenses employing a stabilization mechanism to minimize the effect of asymmetric eyelid bias in settled orientation of the toric contact lens. Related methods of design of such toric contact lenses are also disclosed. The toric contact lens is designed to correct the vision of an astigmatic eye having a spherical power correction need for correcting refractive error and a cylinder power correction need for correcting astigmatism. The toric contact lens includes stabilization zones that are each disposed on horizontal sides of the lens periphery of the contact lens between its central optic zone and the lens edge. The stabilization zones each have a thickness profile defining a plurality of contour lines each of varying thickness between a first, front surface of the contact lens and a second, back surface of the contact lens. The stabilization zones are designed to be contacted by an eyelid margin of an eyelid of a patient wearer. As the eyelid moves across the stabilization zone from a reduced thickness to an increased thickness, the eyelid experiences an increasing force and pressure. This contact and resulting pressure between the eyelid and the stabilization zones forces a rotational orientation of the contact lens to be oriented to the principal meridians of the eye on insertion and to maintain that orientation through the wear period. Ideally, the rotational orientation of the toric contact lens is aligned with the principal meridians of the eye. However, variations and asymmetry in the shape of an eyelid and the eyelid margin of a patient wearer can vary greatly between different patients. This can cause misalignment of the toric contact lens to the principal meridians of an eye as a result of the stabilization zones tracking the shape of an asymmetrically shaped eyelid and eyelid margin.

Thus, in exemplary aspects, to minimize the effect of asymmetric bias of an eyelid of a patient wearer on the alignment of the toric contact lens to the principal meridians of the eye, the portion of the contour lines in the stabilization zones that are configured to intersect with an eyelid margin of an eye of a patient wear are oriented to a target eyelid margin shape of a target eyelid of an average patient wearer. For example, this can be accomplished by condensing the intersecting portion of the contour lines in the stabilization zones to be less concentric to the circumference of the lens. In an example, a first, designated contour line in a stabilization zone is configured to be substantially contained within an open eye resting boundary of the target eyelid margin and provided at a thickness between approximately 73%-80% of a meridian thickness differential (i.e., the difference between the horizontal meridian thickness differential and the vertical meridian thickness differential). The thickness of the first, designated contour line in the stabilization zones being in the aforementioned thickness range of the meridian thickness differential has been found to still allow the orientation and stabilization of the toric contact lens to be influenced by the eyelid of the wearer, which may have an asymmetric shape, for rotational orientation, but also not unduly influenced by asymmetry in the shape of the eyelid of the wearer. This is because with the first, designated contour line in the stabilization zones configured to be substantially contained within the open eye resting boundary of the target eyelid margin during wear, the orientation of the toric contact lens may be primarily influenced by the lower and/or upper point of either side of a respective asymmetrically shaped upper and/or lower eyelid of a patient wearer. This can avoid or reduce an over rotation of the toric contact lens beyond a horizontal meridian alignment due the asymmetric shape of the eyelid and its eyelid margin. This is because the first, designated contour line in the stabilization zones being oriented to be substantially contained within the open eye resting boundary of the target eyelid margin during wear can reduce pressure imbalance between both sides of the eyelid in contact with a respective stabilization zone in the lens. In this manner, the stabilization zone of the toric contact lens is more desensitized to any asymmetric shape of the wearer's eyelid.

In other exemplary aspects, the stabilization zones each have an active zone(s) that includes a portion of the plurality of contour lines defining the thickness gradient of the stabilization zone. The active zone is designed such that an eyelid margin of an eyelid of a patient wearer is configured to move across the active zone and encounter the thickness gradient of the stabilization zone during wear to rotationally orient the toric contact lens. The portion of the contour lines within the active zone(s) can be condensed in shape to be less concentric to the circumference of the lens to be more closely approximate the shape of the target eyelid margin presented to the active zones. This may also provide enhanced tracking and registration of the contact lens orientation to the shape of the eyelid margin of the eyelid of a patient wearer. In yet other exemplary aspects, the thickness gradients of the active zones can also be designed to be substantially orthogonal to the target eyelid margin shape of an eyelid that is targeted to come into contact with the active zones. This can provide an optimized influence of the force and resulting pressure from the interaction of an eyelid margin of an eyelid of a patient wearer to the toric contact lens to influence rotation and stabilization while minimizing the interaction between the eyelid margin and the active zones of the stabilization zones to minimize the effect of asymmetric bias of the eyelid shape of a patient wearer.

In this regard, in an exemplary aspect, a toric contact lens is disclosed. The toric contact lens includes a first surface and a second surface opposite of the first surface, the toric contact lens has a horizontal thickness differential between the first surface and the second surface along a horizontal center axis, and a vertical thickness differential between the first surface and the second surface along a vertical center axis orthogonal to the horizontal center axis. The toric contact lens also includes an optic zone disposed around an optical axis intersecting the horizontal center axis and the vertical center axis, and a lens periphery surrounding the optic zone and extending between the optic zone and a lens edge. The lens periphery comprises a first stabilization zone on a first side of the lens periphery between the optic zone and the lens edge, the first stabilization zone having a first thickness profile comprising a plurality of first contour lines each at a varying thickness between the first surface and the second surface and a second stabilization zone on a second side of the lens periphery opposite the first side, the second stabilization zone between the optic zone and the lens edge, the second stabilization zone having a second thickness profile comprising a plurality of second contour lines each at a varying thickness between the first surface and the second surface. Wherein a first contour line of the plurality of first contour lines oriented to a target upper eyelid margin shape of a target upper eyelid of an average patient wearer configured to be substantially contained within a resting boundary of the target upper eyelid margin, having first thickness between approximately 73%-80% of a meridian thickness differential of the difference between the horizontal thickness differential and the vertical thickness differential and a second contour line of the plurality of second contour lines oriented to the target upper eyelid margin shape configured to be substantially contained within the resting boundary of the target upper eyelid margin, having second thickness between approximately 73%-80% of the meridian thickness differential.

In another exemplar aspect, a method of fabricating a toric contact lens is disclosed. The method includes forming a lens from a volume of lens material, the lens comprising a first surface and a second surface opposite of the first surface; the lens having a horizontal thickness differential between the first surface and the second surface along a horizontal center axis, and a vertical thickness differential between the first surface and the second surface along a vertical center axis orthogonal to the horizontal center axis. The method of fabricating a toric contact lens also includes an optic zone disposed around an optical axis intersecting the horizontal center axis and the vertical center axis and a lens periphery surrounding the optic zone and extending between the optic zone and a lens edge; the lens periphery comprising a first stabilization zone on a first side of the lens periphery between the optic zone and the lens edge, the first stabilization zone having a first thickness profile comprising a plurality of first contour lines each at a varying thickness between the first surface and the second surface and a second stabilization zone on a second side of the lens periphery opposite the first side, the second stabilization zone between the optic zone and the lens edge, the second stabilization zone having a second thickness profile comprising a plurality of second contour lines each at a varying thickness between the first surface and the second surface. Wherein a first contour line of the plurality of first contour lines oriented to a target upper eyelid margin shape of a target upper eyelid of an average patient wearer configured to be substantially contained within a resting boundary of the target upper eyelid margin, having first thickness between approximately 73%-80% of a meridian thickness differential of the difference between the horizontal thickness differential and the vertical thickness differential and a second contour line of the plurality of second contour lines oriented to the target upper eyelid margin shape configured to be substantially contained within the resting boundary of the target upper eyelid margin, having second thickness between approximately 73%-80% of the meridian thickness differential.

Additional features and advantages will be set forth in the detailed description that follows and, in part, will be readily apparent to those skilled in the art from the description or recognized by practicing the aspects as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings illustrate one or more aspects and, together with the description, serve to explain the principles and operation of the various aspects.

### BRIEF DESCRIPTION OF THE FIGURES

The foregoing and other features and advantages of the disclosure will be apparent from the following, more particular descriptions of the aspects of the disclosure, as illustrated in the accompanying drawings.

FIGS. 1A and 1B are schematic diagrams of a normal eye and an astigmatic eye, respectively;

FIG. 2 shows a model eye fitted with a toric contact lens with stabilization zones configured to encounter the eyelids of the eye for orienting the toric contact lens to the eye relative to the principal meridians of the eye;

FIG. 3 shows eyelid shape data for the upper and lower eyelids of right eyes, whereby each line is polynomial fit to a series of points that were delineated along the photographs of the eyelid margin with the eye in primary;

FIGS. 4A and 4B illustrate full and partial thickness profiles of an exemplary toric contact lens illustrating stabilization zones each having a varying thickness on each side of the optic zone of the lens about the vertical meridian, wherein the stabilization zones include active zones with contour lines oriented to a target eyelid margin shape(s) of a target eyelid(s) of an average patient wearer or improved stabilization in wearers with an asymmetric eyelid(s);

FIGS. 5A and 5B are side-by-side illustrations of the partial thickness profile diagrams in FIGS. 4B and 4B, respectively;

FIG. 6 is a graph illustrating an exemplary thickness profile along a vertical center axis of a toric contact lens in FIG. 4A that includes stabilization zones that include active zones with contour lines oriented to a target eyelid margin shape(s) of a target eyelid(s) of an average patient wearer or improved stabilization in wearers with an asymmetric eyelid(s), versus the toric contact lens in FIG. 5B;

FIG. 7 shows a plot of an example design image overlaid with the original lid shape polynomials;

FIG. 8 illustrates a plot, separately for the upper and lower eyelids, showing an average eyelid margin shape was obtained by taking the median of all polynomials of eyelid shape data at each millimeter interval along the X-axis shapes have been centered over the origin;

FIG. 9 shows the left-right “flipped” and “non-flipped” eyelid shape data plotted both together on the same axes;

FIG. 10 shows the average of the “flipped” and “non-flipped” eyelid shape data, whereby the mean of the Y-axis values for each was taken at each millimeter interval;

FIG. 11 shows the top-bottom “flipped” and “non-flipped” eyelid shape data plotted both together on the same axes; and

FIGS. 12A and 12B are a flowchart illustrating an exemplary process of designing a toric contact lens that has stabilization zones, each having a varying thickness on each side of the optic zone of the lens about the vertical meridian, wherein the stabilization zones include active zones with contour lines oriented to a target eyelid margin shape(s) of a target eyelid(s) of an average patient wearer or improved stabilization in wearers with an asymmetric eyelid(s), including but not limited to the toric contact lens in FIGS. 4A and 4B.

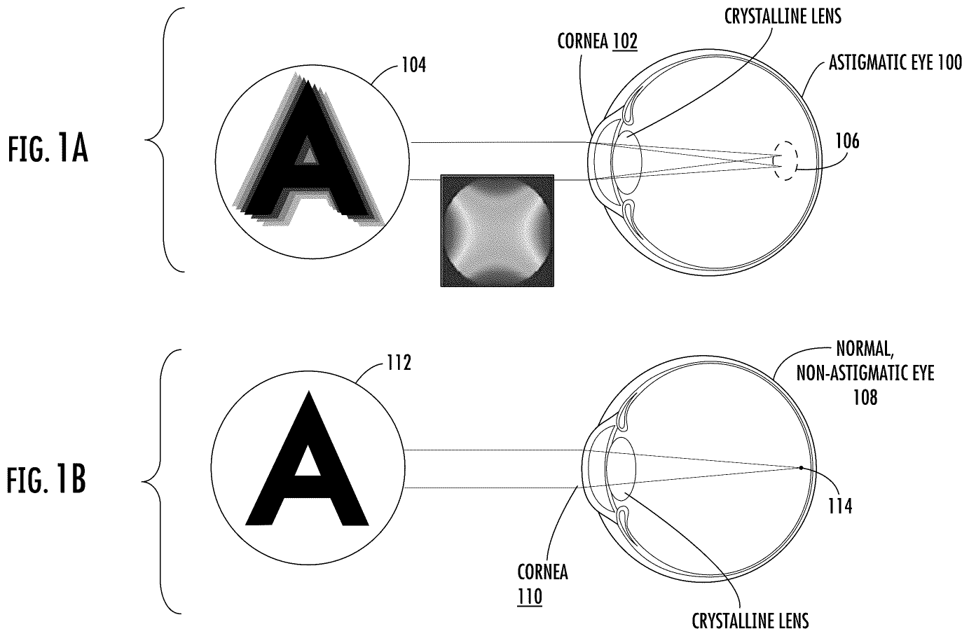

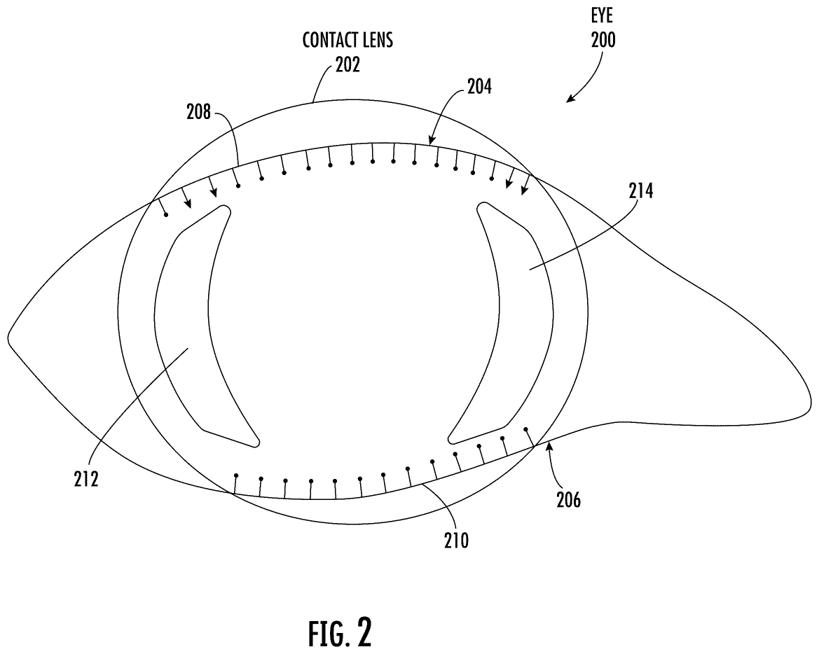

### DETAILED DESCRIPTION

Aspects disclosed herein include toric contact lenses employing a stabilization mechanism to minimize the effect of asymmetric eyelid bias in settled orientation of the toric contact lens. Related methods of design of such toric contact lenses are also disclosed. The toric contact lens is designed to correct the vision of an astigmatic eye having a spherical power correction need for correcting refractive error and a cylinder power correction need for correcting astigmatism. The toric contact lens includes stabilization zones that are each disposed on horizontal sides of the lens periphery of the contact lens between its central optic zone and the lens edge. The stabilization zones each have a thickness profile defining a plurality of contour lines each of varying thickness between a first, front surface of the contact lens and a second, back surface of the contact lens. The stabilization zones are designed to be contacted by an eyelid margin of an eyelid of a patient wearer. As the eyelid moves across the stabilization zone from a reduced thickness to an increased thickness, the eyelid experiences an increasing force and pressure. This contact and resulting pressure between the eyelid and the stabilization zones forces a rotational orientation of the contact lens to be oriented to the principal meridians of the eye on insertion and to maintain that orientation through the wear period. Ideally, the rotational orientation of the toric contact lens is aligned with the principal meridians of the eye. However, variations and asymmetry in the shape of an eyelid and the eyelid margin of a patient wearer can vary greatly between different patients. This can cause misalignment of the toric contact lens to the principal meridians of an eye as a result of the stabilization zones tracking the shape of an asymmetrically shaped eyelid and eyelid margin.

Thus, in exemplary aspects, to minimize the effect of asymmetric bias of an eyelid of a patient wearer on the alignment of the toric contact lens to the principal meridians of the eye, the portion of the contour lines in the stabilization zones that are configured to intersect with an eyelid margin of an eye of a patient wear are oriented to a target eyelid margin shape of a target eyelid of an average patient wearer. For example, this can be accomplished by condensing the intersecting portion of the contour lines in the stabilization zones to be less concentric to the circumference of the lens. In an example, a first, designated contour line in a stabilization zone is configured to be substantially contained within an open eye resting boundary of the target eyelid margin and provided at a thickness between approximately 73%-80% of a meridian thickness differential (i.e., the difference between the horizontal meridian thickness differential and the vertical meridian thickness differential). The thickness of the first, designated contour line in the stabilization zones being in the aforementioned thickness range of the meridian thickness differential has been found to still allow the orientation and stabilization of the toric contact lens to be influenced by the eyelid of the wearer, which may have an asymmetric shape, for rotational orientation, but also not unduly influenced by asymmetry in the shape of the eyelid of the wearer. This is because with the first, designated contour line in the stabilization zones configured to be substantially contained within the open eye resting boundary of the target eyelid margin during wear, the orientation of the toric contact lens may be primarily influenced by the lower and/or upper point of either side of a respective asymmetrically shaped upper and/or lower eyelid of a patient wearer. This can avoid or reduce an over-rotation of the toric contact lens beyond a horizontal meridian alignment due to the asymmetric shape of the eyelid and its eyelid margin. This is because the first designated contour line in the stabilization zones being oriented to be substantially contained within the open eye resting boundary of the target eyelid margin during wear can reduce pressure imbalance between both sides of the eyelid in contact with a respective stabilization zone in the lens. In this manner, the stabilization zone of the toric contact lens is more desensitized to any asymmetric shape of the wearer's eyelid.

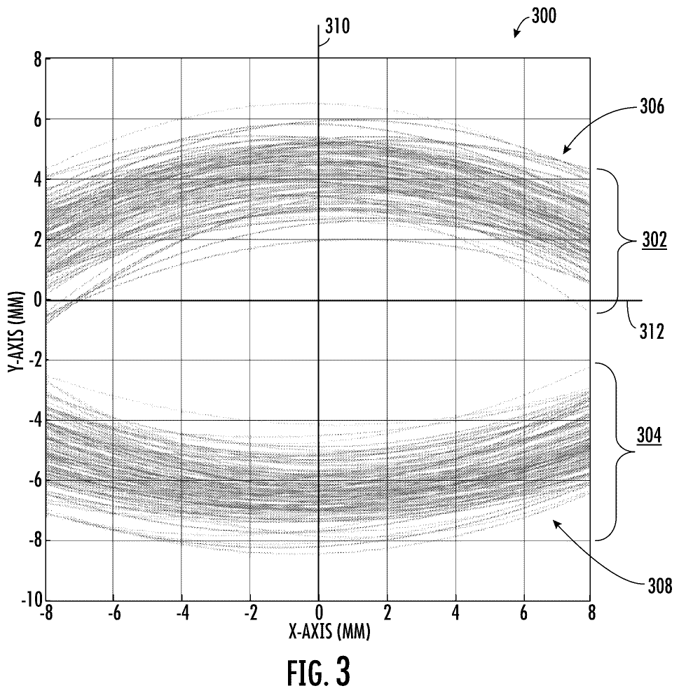

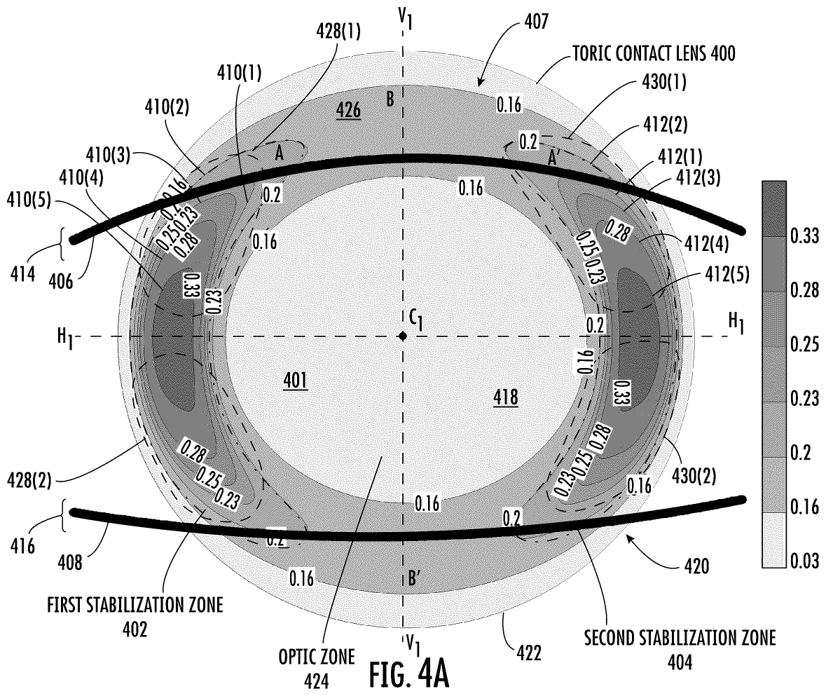

In this regard, to show the potential for variation and asymmetry in eyelid margin shape among a population, FIG. 3 is provided. FIG. 3 is a graph 300 that shows eyelid shape data 302, 304 for a population of respective upper eyelids and lower eyelids of right eyes. The eyelid shape data 302, 304 are shown as respective plurality of lines 306, 308 that show the shape of the eyelid margins of a populations of upper eyelids and lower eyelids. Each line 306, 308 is a 2nd order polynomial fit to a series of points that were delineated along the photographs of the eyelid margin with the eye in primary gaze. As shown in FIG. 3, the shape of eyelid margins according to the lines 306, 308 of the respective eyelid shape data 302, 304 can vary greatly between different persons in a population. For example, some eyelid margin shapes slope down nasally due to the respective eyelid sloping down nasally, while others slope down temporally. In either of these cases, the eyelid margin is asymmetric to the eye and its principal meridians as the vertical meridian 310 and horizontal meridian 312 if the eye is astigmatic. If an eyelid margin is asymmetric to its eye, a toric contact lens with a stabilization zone(s) presented to such an eye will also have an asymmetric biased tilt/rotation from a symmetrical alignment on the eye about the vertical and/or horizontal meridians 310, 312. This causes the corrective powers in the toric contact lens to be misaligned with one or both of the principal meridians of the eye. It is important in a toric contact lens for the corrective powers for both principal meridians of the eye to be aligned with the principal meridians of the eye for correcting astigmatic vision.

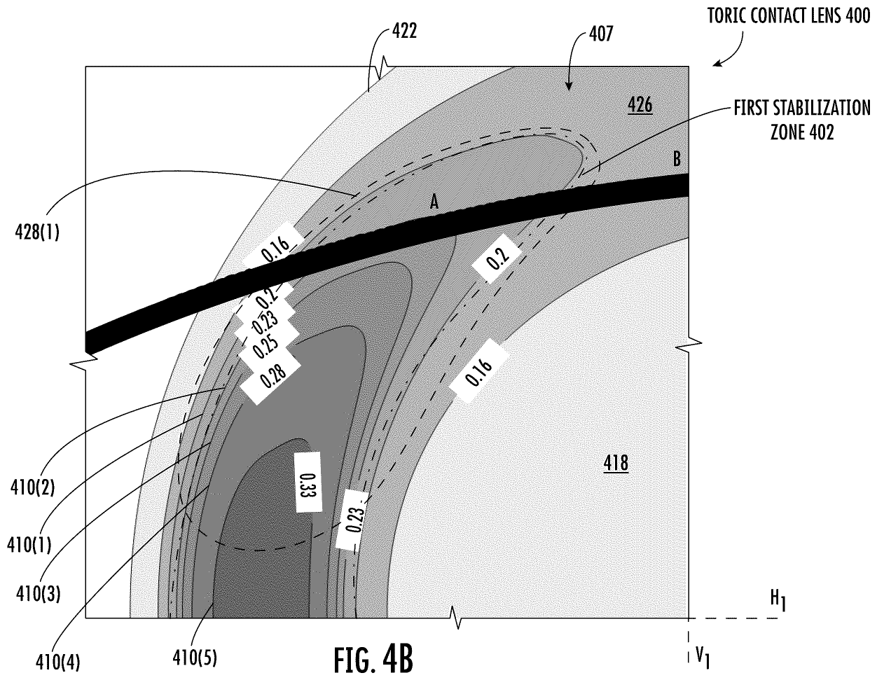

To provide a toric contact lens that is able to orient itself to be substantially aligned with the principal meridians of a fitted eye, even if the fitted eye has asymmetric eyelid shapes, the toric contact lens 400 in FIGS. 4A and 4B is provided. FIG. 4A is a diagram illustrating a thickness profile of an exemplary toric contact lens 400 that has first and second stabilization zones 402, 404. FIG. 4B is a close-up diagram of the left, upper portion of the first stabilization zone 402 of the toric contact lens 400 illustrating additional detail of the thickness profile of the first stabilization zone 402, which is also applicable to the second stabilization zone 404. With reference back to FIG. 4A, the toric contact lens 400 also has a thin zone 407 outside of the first and second stabilization zones 402, 404. The thin zone 407 has superior region B and inferior region B′ of the toric contact lens 400 that intersect the vertical center axis V₁. The first and second stabilization zones 402, 404 of the toric contact lens 400 are each configured to interface with the eyelids of an eye a patient wearer to improve stabilization and alignment of the toric contact lens substantially to the principal meridians of the eye, even if the eyelid shapes are asymmetric. An asymmetric eye shape is one in which the eyelid is not symmetrical about the vertical meridian of the eye. In this example, with reference to FIG. 4A, the first and second stabilization zones 402, 404 are symmetrical about a vertical center axis V₁ of the toric contact lens 400. The first and second stabilization zones 402, 404 include thickness profiles shown by contour lines that are configured to intersect with target upper and lower eyelid margins 406, 408 according to an average eyelid margin shape of eyelids of an average patient wearer and still orient the toric contact lens substantially to the principal meridians of the eye, even in view of the eyelid margin shape of the patient wearer being asymmetric.

In this regard, as discussed in more detail below, a designated first and second contour lines 410(1), 412(1) in each of the respective first and second stabilization zones 402, 404 that are configured to be substantially contained within a target open eye resting boundary (“resting boundary”) 414, 416 of the respective target upper and lower eyelid margins 406, 408, has a thickness between approximately 73%-80% of a meridian thickness differential (i.e., the difference between the horizontal center axis H₁ thickness differential and the vertical center axis V₁ thickness differential). This thickness of the designated first and second contour lines 410(1), 412(1) in the first and second stabilization zones 402, 404 being in the aforementioned thickness range of the meridian thickness differential has been found to still allow the orientation and stabilization of the toric contact lens 400 to be influenced by the asymmetric-shaped eyelids of a patient wearer for rotational orientation, but also not be unduly influenced by any asymmetry in the shape of the patient wearer's eyelid. This is because with the designated first and second contour lines 410(1), 412(1) in the respective first and second stabilization zones 402, 404 are configured to be substantially contained within the target resting boundary 414, 416 of the target eyelid margins 406, 408 during wear, the orientation of the toric contact lens 400 may be primarily influenced by the lower or upper point of either side of a respective asymmetrically-shaped upper and lower eyelid of a patient wearer. This can avoid or reduce an over rotation of the toric contact lens 400 beyond a horizontal meridian alignment in a fitted eye due to the asymmetric shape of the eyelid and its eyelid margin of a patient wearer. This is because the designated first and second contour lines 410(1), 412(1) in the respective first and second stabilization zones 402, 404 being oriented to be substantially contained within the target resting boundary 414, 416 of the target eyelid margins 406, 408 can reduce pressure imbalance between both sides of the eyelid of a patient wearer in contact with a respective first and second stabilization zone 402, 404 in the toric contact lens 400. In this manner, the first and second stabilization zones 402, 404 of the toric contact lens 400 are more desensitized to any asymmetric shape of the patient wearer's eyelid.

With continued reference to FIG. 4A, the toric contact lens 400 is a lens material 401 that includes a first surface 418 and a second surface 420 opposite the first surface 418. The toric contact lens 400 has a horizontal thickness differential between the first surface 418 and the second surface 420 along the horizontal center axis H₁. In this example, the horizontal thickness differential is 0.365 millimeters (mm), which is the thickness differential between a lens edge 422 of the toric contact lens 400 and the maximum thickness in the first and second stabilization zones 402, 404 along the horizontal center axis H₁. The toric contact lens 400 also has a vertical thickness differential between the first surface 418 and the second surface 420 along the vertical center axis V₁ orthogonal to the horizontal center axis H₁. In this example, the vertical thickness differential is 0.19 mm, which is the thickness differential between the lens edge 422 of the toric contact lens 400 and the maximum thickness along the vertical center axis V₁. The toric contact lens 400 also includes an optic zone 424 disposed around a center, optical axis C₁ intersecting the vertical center axis V₁ and the horizontal center axis H₁. The toric contact lens 400 also includes a lens periphery 426 that is outside of and surrounding the optic zone 424 and extends between the optic zone 424 and the lens edge 422.

With continuing reference to FIG. 4A, the first stabilization zone 402 is on the first, left side of the lens periphery 426 between the optic zone 424 and the lens edge 422. The first stabilization zone 402 has a first thickness profile that comprises a plurality of first contour lines 410(1)-410(5) each at varying thicknesses of the toric contract lens 400 between the first surface 418 and the second surface 420 and each shown with different thickness measurements in millimeters. Note that the first contour lines 410(1)-410(5) are not hard transitions in the first stabilization zone 402, but rather imaginary lines that show a specific thickness in a specific outlined area in the first stabilization zone 402. The first stabilization zone 402 has a first thickness profile that is of varying thickness. In this example, the plurality of first contour lines 410(1)-410(5) are at respective thickness of 0.23 mm, 0.16 mm, 0.25 mm, 0.28 mm, and 0.33 mm.

The second stabilization zone 404 is on the second, right side of the lens periphery 426 between the optic zone 424 and the lens edge 422. The second stabilization zone 404 has a second thickness profile that comprises a plurality of second contour lines 412(1)-412(5) also each at varying thicknesses of the toric contract lens 400 between the first surface 418 and the second surface 420 and each shown with different thickness measurements in millimeters. Note that the second contour lines 412(1)-412(5) are not hard transitions in the second stabilization zone 404, but rather imaginary lines that show a specific thickness in a specific outlined area in the second stabilization zone 404. The second stabilization zone 404 has a second thickness profile that is of varying thickness. In this example, the plurality of second contour lines 412(1)-412(5) are at respective thickness of 0.23 mm, 0.16 mm, 0.25 mm, 0.28 mm, and 0.33 mm. This is because in this example, the first and second stabilization zones 402, 404 are symmetrical to each other about the vertical center axis V₁, such that the respective first and second contour lines 410(1)-410(5), 412(1)-412(5) are also symmetrical to each other about the vertical center axis V₁. The first and second stabilization zones 402, 404 do not intersect the vertical center axis V₁ in this example, so as to not interfere with the optic zone 424.

With continuing reference to FIG. 4A, the first stabilization zone 402 includes a first, upper active zone 428(1) and a second, lower active zone 428(2) that are each configured to intersect with the left side of a respective upper and lower eyelid margin of a fitted eye. The first, upper active zone 428(1) and a second, lower active zone 428(2) intersect a portion of the first contour lines 410(1)-410(5) that are configured to intersect with the left side of a respective upper and lower eyelid margin of a fitted eye to orient and stabilize the toric contact lens 400 to an eye of a patient wearer. The first, upper active zone 428(1) and the second, lower active zone 428(2) each have a thickness gradient of an increasing thickness. The thickness differential is shown by the variations in the thickness of the first contour lines 410(1)-410(5), wherein the thickness variation is from a thickness of 0.16 mm to a maximum thickness of 0.365 mm, providing a thickness differential of 0.205 mm. The thin zone 407 has a maximum thickness of 0.2 mm and a thickness variation of 0.2 mm to the lens edge 422 in this example. The first, upper active zone 428(1) and a second, lower active zone 428(2) encompass a thickness gradient of the first stabilization zone 402 such that when an upper and lower eyelid intersect and start to move across the first, upper active zone 428(1) and a second, lower active zone 428(2), the upper and lower eyelid of a patient wearer will encounter an increase in thickness across the thickness gradient which will result in a resistance. The pressure imbalance between the upper active zone 428(1) and the upper eyelid of a patient wearer causes the toric contact lens 400 to orient itself relative to the upper eyelid margin of the upper eyelid of the patient wearer. Similarly, the pressure imbalance between the lower active zone 428(2) and the lower eyelid of a patient wearer can cause the toric contact lens 400 to orient itself relative to the lower eyelid margin of the lower eyelid of the patient wearer.

With continuing reference to FIG. 4A, the second stabilization zone 404 includes a first, upper active zone 430(1) and a second, lower active zone 430(2) that are each configured to intersect with the right side of a respective upper and lower eyelid margin of a fitted eye. The first, upper active zone 430(1) and a second, lower active zone 430(2) intersect a portion of the second contour lines 412(1)-412(5) that are configured to intersect with the left side of a respective upper and lower eyelid margin of a fitted eye to orient and stabilize the toric contact lens 400 to an eye of a patient wearer. The first, upper active zone 430(1) and the second, lower active zone 430(2) each have a thickness gradient of an increasing thickness. The thickness differential is shown by the variations in the thickness of the second contour lines 412(1)-412(5), wherein the thickness variation is from a thickness of 0.16 mm to a maximum thickness of 0.365 mm, providing a thickness differential of 0.205 mm. The first, upper active zone 430(1) and a second, lower active zone 430(2) encompass a thickness gradient of the second stabilization zone 404 such that when an upper and lower eyelid intersect and start to move across the first, upper active zone 430(1) and a second, lower active zone 430(2), the upper and lower eyelid of a patient wearer will encounter an increase in thickness across the thickness gradient which will result in a resistance. The pressure imbalance between the upper active zone 428(1) and the upper eyelid of a patient wearer causes the toric contact lens 400 to orient itself relative to the upper eyelid margin of the upper eyelid of the patient wearer. Similarly, the pressure imbalance between the lower active zone 430(2) and the lower eyelid of a patient wearer can cause the toric contact lens 400 to orient itself relative to the lower eyelid margin of the lower eyelid of the patient wearer.

Thus, in this example, the toric contact lens 400 orientation will track (i.e., register to) the shape of the eyelid margin of the upper and/or lower eyelids and follow the eyelid margin shape of a patient wearer, because the rotational alignment of the toric contact lens 400 is driven based on the eyelid shape through the first and second stabilization zones 402, 404. However, the shape of the eyelids and the eyelid margins of patients can vary greatly between different patients. For example, some eyelids slope down nasally while others slope down temporally. In either of these cases, the eyelid margin is asymmetric to the eye and its principal meridians if the eye is astigmatic. If an eyelid margin is asymmetric to its eye, a toric contact lens with a stabilization zone(s) presented to such an eye will also have an asymmetric biased tilt/rotation from a symmetrical alignment on the eye. This causes the corrective powers in the toric contact lens to be misaligned with one or both of the principal meridians of the eye. It is important in a toric contact lens for the corrective powers for both principal meridians of the eye to be aligned with the principal meridians of the eye for correcting astigmatic vision.

Thus, in this example, to minimize the effect of asymmetric bias of an eyelid of a patient wearer on the alignment of the toric contact lens 400 in FIGS. 4A and 4B to the principal meridians of the eye, the active zones 428(1), 428(2), 430(1), 430(2) and their respective first and second contour lines 410(1)-410(5), 412(1)-412(5) that are configured to intersect with respective upper and lower eyelid margins of upper and lower eyelids of a patient wearer, are oriented to a target eyelid margin shape of a target eyelid of an average patient wearer. In this manner, the active zones 428(1), 428(2), 430(1), 430(2) will be primarily influenced by the lower or upper point of either side of a respective asymmetrically-shaped upper and lower eyelid of a patient wearer. In this regard, the designated, first contour line 410(1) in the first, upper active zone 428(1) of the first stabilization zone 402 is oriented to the target eyelid margin shape of the target upper eyelid margin 406 of an average patient wearer configured to be substantially contained within the target resting boundary 414 of a target eyelid margin. Also, in this example, the designated, second contour line 412(1) in the first, upper active zone 430(1) of the second stabilization zone 404 is oriented to the target eyelid margin shape of the target upper eyelid margin 406 of an average patient wearer configured to be substantially contained within the target resting boundary 414 of a target eyelid margin. The designated, first and second contour lines 410(1), 412(1) are shaped in their respective upper active zones 428(1), 430(1) to be substantially parallel to the target upper eyelid margin 406 in an area of an upper eyelid margin they are configured to intersect with in a patient wearer. The other first and second contour lines 410(2)-410(5), 412(2)-412(5) can also be shaped in their respective upper active zones 428(1), 430(1) to be substantially parallel to the target upper eyelid margin 406 in an area of an upper eyelid margin they are configured to intersect in a patient wearer. This can provide enhanced tracking and registration of the toric contact lens 400 orientation to the shape of the eyelid margin of the eyelid of a patient wearer that has asymmetrically-shaped eyelids.

Also, in this example, the designated first contour line 410(1) defines a first thickness in the first stabilization zone 402 between approximately 73%-80% of the meridian thickness differential of the difference between the horizontal thickness differential and the vertical thickness differential. The designated first contour line 410(1) proceeds more towards a superior nasal quadrant B than a superior temporal quadrant A to stay substantially contained within the target eyelid margin 406. Thus, in a patient wearer, the first contour line 410(1) of the toric contact lens 400 will more greatly influence the orientation of the toric contact lens 400 in a fitted eye. And in this example, the first contour line 410(1) is not substantially the shape of the target upper eyelid margin 406. Thus, in a patient wearer of the toric contact lens 400, an asymmetric interaction between the patient's eyelid and thickness differential would likely lead to a counterclockwise rotation of the toric contact lens 400 and non-zero mean settled location. And in this example, the first contour line 410(1) is not substantially the shape of the target upper eyelid margin 406.

The designated, second contour line 412(1) defines a second thickness in the second stabilization zone 404 also between approximately 73%-80% of the meridian thickness differential of the difference between the horizontal thickness differential and the vertical thickness differential. Note that the thickness of the designated first and second contour lines 410(1), 412(1) in the first and second stabilization zones 402, 404 being in the aforementioned thickness range of the meridian thickness differential has been found to still allow the orientation and stabilization of the toric contact lens 400 to be influenced by the asymmetric-shaped eyelids of a patient wearer for rotational orientation, but also not be unduly influenced by any asymmetry in the shape of the patient wearer's eyelid. This is because with the first, designated first and second contour lines 410(1), 412(1) in the respective first and second stabilization zones 402, 404 are configured to be substantially contained within the target resting boundary 414, 416 of the target eyelid margins 406, 408 during wear, the orientation of the toric contact lens 400 may be primarily influenced by the lower or upper point of either side of a respective asymmetrically-shaped upper and lower eyelid of a patient wearer. This can avoid or reduce an over rotation of the toric contact lens 400 beyond a horizontal meridian alignment in a fitted eye due to the asymmetric shape of the eyelid and the eyelid margin of a patient wearer. This is because the designated first and second contour lines 410(1), 412(1) in the respective first and second stabilization zones 402, 404 being oriented to be substantially contained within the target resting boundary 414, 416 of the target eyelid margins 406, 408 can reduce pressure imbalance between both sides of the eyelid of a patient wearer in contact with a respective first and second stabilization zone 402, 404 in the toric contact lens 400. In this manner, the first and second stabilization zones 402, 404 of the toric contact lens 400 are more desensitized to any asymmetric shape of the patient wearer's eyelid.

In this example, the first thickness of the designated first and second contour lines 410(1), 412(1) is 0.23 mm between the first surface 418 and the second surface 420. The horizontal thickness differential between the first surface 418 and the second surface 420 along the horizontal center axis H₁ is 0.365 millimeters (mm), which is the thickness differential between a lens edge 422 of the toric contact lens 400 and the maximum thickness in the first and second stabilization zones 402, 404 along the horizontal center axis H₁. The vertical thickness differential between the first surface 418 and the second surface 420 along the vertical center axis V₁ orthogonal to the horizontal center axis H₁ is 0.19 mm. Thus, the meridian thickness differential between the horizontal thickness differential and the vertical thickness differential in this example is 0.175 (i.e., 0.365 mm-0.19 mm). The designated first and second contour lines 410(1), 412(1) have a thickness of 0.23 mm. Thus, the designated first and second contour lines 410(1), 412(1) being of thickness of 0.23 mm is 77% of the thickness differential between the vertical center axis V₁ and the horizontal center axis H₁, as follows:

77%=0.365 horizontal thickness differential−0.23 mm contour line/(0.365 horizontal thickness differential−0.19 vertical thickness differential)

As discussed above, the first and second contour lines 410(1)-410(5), 412(1)-412(5) in the respective active zones 428(1), 428(2), 430(1), 430(2) in FIGS. 4A and 4B are oriented to substantially match the respective target eyelid margin 406, 408 shapes at their points of intersection to provide improved orientation and stabilization of the toric contact lens 400 in a fitted eye. This was achieved in part in this example, by altering the shape and orientation of the designated first and second contour lines 410(1), 412(1) in the respective active zones 428(1), 428(2), 430(1), 430(2) to be substantially non-concentric with the lens edge 422, since the shape of the target eyelid margins 406, 408 are non-concentric with the lens edge 422. In this example, each of the first and second contour lines 410(1)-410(5), 412(1)-412(5) in the respective active zones 428(1), 428(2), 430(1), 430(2) can be designed to be substantially non-concentric with the lens edge 422. Also, in this example, the active zones 428(1) 430(1), 430(2) are designed such the thickness gradient being a direction of greatest slope along its length is structured such that it is oriented to be orthogonal to the shape of the target upper eyelid margin 406. This can further minimize interaction between the eyelid margin of a patient wearer and the active zones 428(1), 430(1) of the respective first and second stabilization zones 402, 404 of the toric contact lens 400 across a patient population and reduce mean lens orientation to surface normal of the toric contact lens 400. This can provide an optimized influence of the force and resulting pressure from interaction of an eyelid margin of an eyelid of a patient wearer to the toric contact lens 400 to influence rotation and stabilization while minimizing the interaction between the eyelid margin and the active zones 428(1), 430(1) of the respective first and second stabilization zones 402, 404 to minimize the effect of asymmetric bias of the eyelid shape of a patient wearer.

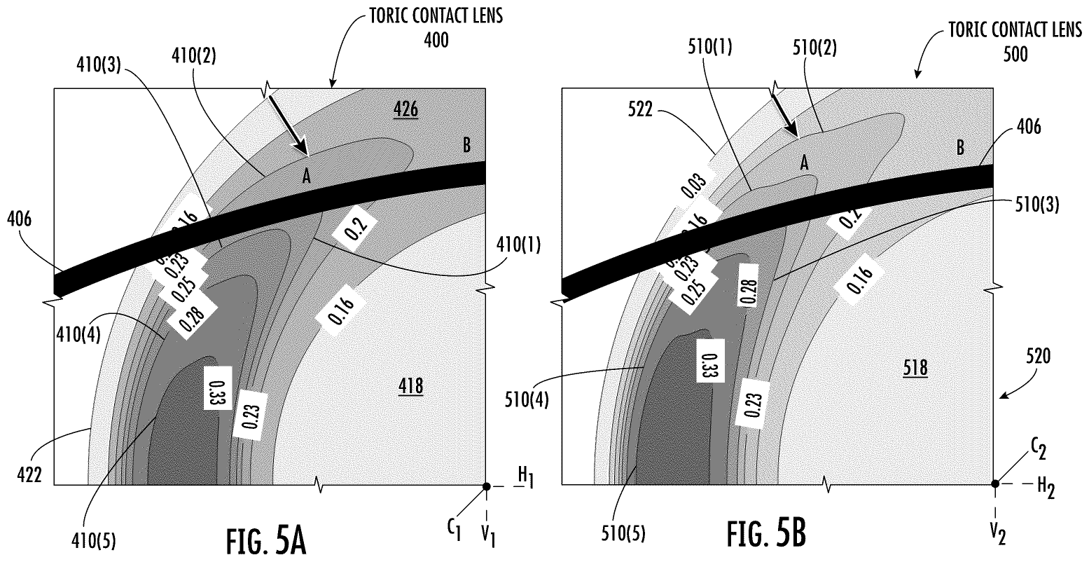

FIGS. 5A and 5B are side-by-side illustrations of the thickness profiles between the first and second surface 418, 420 of the toric contact lens 400 in FIG. 4A and a first and second surface 518, 520 of another exemplary toric contact lens 500, respectively. As shown in FIG. 5B, the designated first contour line 510(1) is of a thickness of 0.23 mm that is 77% of the thickness differential between the vertical center axis V₁ and the horizontal center axis H₁ in the toric contact lens 500 is substantially below the target upper eyelid margin 406 in an active zone 528(1). The designated first contour line 510(1) of a thickness of 0.23 mm proceeds beyond the target upper eyelid margin 406 in the superior nasal quadrant A which is on the superior temporal quadrant B. Thus, in a patient wearer, the first contour line 510(1) of the toric contact lens 500 will more greatly influence the orientation of the toric contact lens 500 in a fitted eye and be more susceptible to misalignment with the principal meridians of a patient wearer that has an asymmetric eyelid shape. And in this example, the first contour line 510(1) of the toric contact lens 500 in FIG. 5B is not substantially the shape of the target upper eyelid margin 406. Thus, in a patient wearer of the toric contact lens 500, an asymmetric interaction between the patient's eyelid and thickness differential would likely lead to a counterclockwise rotation of the toric contact lens 500 and non-zero mean settled location.

In addition, it has been found that a toric contact lens like the design of the toric contact lens 400 in FIG. 4A can recover from an initial mis-rotation. The toric contact lens 400 continues to rotate steadily back to an orientation of its horizontal center axis H₁ substantially oriented to the horizontal meridian of the eye of a patient wearer not just while the eyelid is actively blinking, but also while the eye remains open. From this observation it can be concluded that a thickness gradient from the vertical thickness differential on the inferior region B′ and superior region B of the toric contact lens 400 that are typically covered by the eyelid when a wearer eye is open could provide shorter stabilization times and further reduce mean settled error due to the lens-eyelid interactions improvement for those specific regions of the toric contact lens 400. The introduction of the vertical thickness differential along the vertical center axis V₁ may also provide or maintain the toric contact lens 400 performance for a larger range of eyelid geometries of patient wearers falling further out from an average eyelid profile.

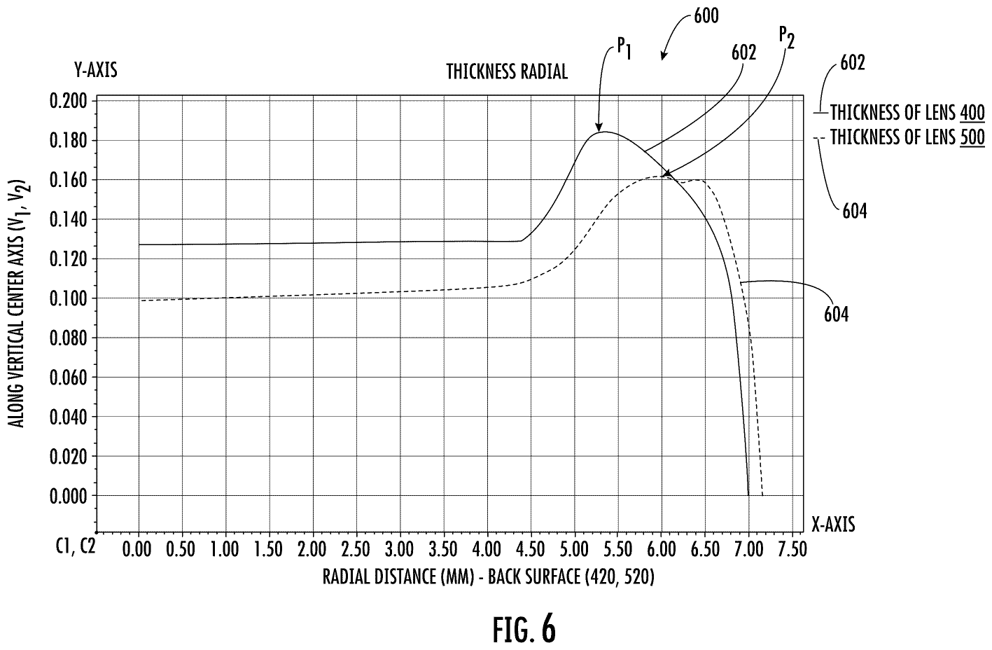

In this regard, the vertical thickness differential profile between the toric contact lens 400 in FIG. 4A (also shown in partial view in FIG. 5A) and the toric contact lens 500 in FIG. 5B is shown in the graph 600 in FIG. 6. The graph 600 in FIG. 6 illustrates illustrating exemplary thickness profiles (in mm) (Y-axis) along a vertical center axis V₁, V₂ as function of radius (X-axis) from respective optical axes C₁, C₂ of the respective toric contact lens 400 in FIG. 4A as compared to the toric contact lens 500 in FIG. 5B. As shown in FIG. 6, to achieve the thickness gradient in the superior region B and inferior region B′ of the toric contact lens 400, the peak thickness in the vertical center axis V₁ of the toric contact lens 400 has been positioned radially inward and closer to the optical axis C₁ as shown in curve 602 than in the toric contact lens 500 in FIG. 5B as shown in curve 604 in FIG. 6. The graph 600 in FIG. 6 demonstrates the comparison of cross-sectional thickness profile along the vertical center axis V₁ for the toric contact lens 400 in FIG. 4A, to the cross-sectional thickness profile along the vertical center axis V₂ for the toric contact lens 500 in FIG. 5B.

As discussed above, the shape and orientation of the designated first and second contour lines 410(1), 412(1) in the respective active zones 428(1), 428(2), 430(1), 430(2) of the toric contact lens 400 in FIG. 4A are substantially non-concentric to be substantially the shape of the target eyelid margins 406, 408 since the shape of the target eyelid margins 406, 408 are non-concentric with the lens edge 422. In this regard, as shown in FIG. 6, a point of peak thickness P₁ along the vertical center axis V₁ for the toric contact lens 400 in FIG. 4A in this example occurs at a radial distance of approximately 5.25 mm versus a point of peak thickness P₂ of 6.5 mm along the vertical center axis V₂ for the toric contact lens 500 in FIG. 5B. The offset points that define the spline at each vertical center axis V₁, V₂ between the respective points of peak thickness P₁, P₂ and a respective lens edge 422, 522 of the respective toric contact lenses 400, 500 (see also, FIGS. 5A and 5B), begin increasing in value by an offset amount on either side of the respective vertical center axis V₁, V₂. Thus, the respective toric contact lenses 400, 500 increase in cross-sectional thickness to provide their thickness gradient. This thickness gradient can be evidenced at point B in the toric contact lens 400 in FIG. 4A where the 0.16 mm contour line is shifted inwards radially from the lens edge 422, whereas in the 0.16 mm contour line in the toric contact lens 500 in FIG. 5B is largely concentric to the outer diameter of its lens edge 522. By the 0.16 mm contour line in the active zone 428(1), 428(2) in the toric contact lens 400 in FIG. 4A being shifted inward as shown in FIG. 6, the shape of the 0.16 mm contour line in the active zone 428(1), 428(2) is substantially the same as the shape of the target upper eyelid margin 406 for the orientation of the toric contact lens 400 to be influenced by the target upper eyelid margin 406.

As discussed above, in the example of the toric contact lens 400 in FIG. 4A, the designated first contour lines 410(1) and/or 412(1) in the respective active zones 428(1), 428(2) and/or 430(1), 430(2) of the respective first and second stabilization zones 402, 404 being shaped to the target eyelid margins 406, 408 to be substantially contained within the resting boundary of a eyelid margin of an eyelid of a patient wearer during wear is based on determining the shape of the target eyelid margins 406, 408. This is so the toric contact lens 400 may be primarily influenced by the lower and/or upper point of either side of a respective asymmetrically shaped upper and/or lower eyelid of a patient wearer. This can avoid or reduce an over rotation of the toric contact lens 400 beyond a horizontal meridian alignment due the asymmetric shape of the eyelid and its eyelid margin.

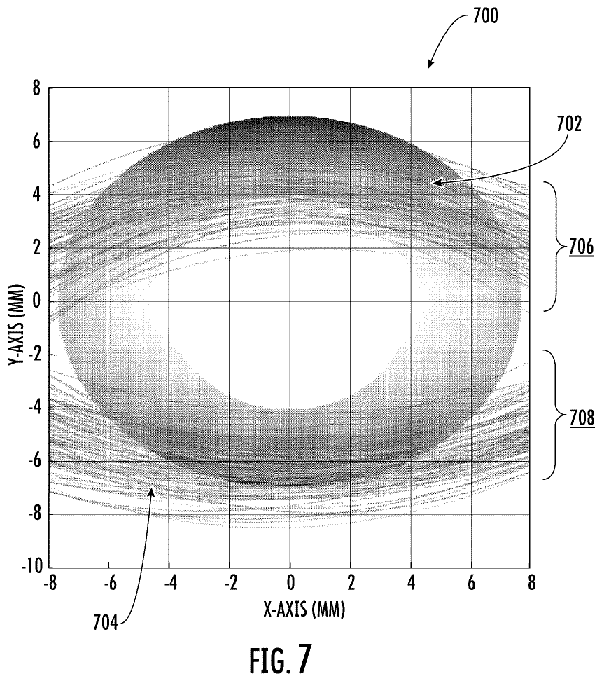

To visualize the shape of the contour lines 410(1)-410(5), 412(1)-412(5) in the respective active zones 428(1), 428(2) and 430(1), 430(2) of the design of the toric contact lens 400. FIG. 7 is provided. FIG. 7 is a plot 700 of the final design image overlaid with upper and lower eyelid shape data 702, 704 in the form of polynomials curves 706, 708 across a patient population. This is one example of how eyelid shape data may be used to determine respective average target eyelid margins 406, 408 to create the design of the toric contact lens 400 in FIG. 4A.

Another technique could be developed through discussion at a high level of expertise in mathematics, topology, data analysis, and 3D modeling. Instead of the example described, another method of design might involve one or more of the following:
Polynomial functions with of higher degrees, or other mathematical functions to fit the eyelid shape data.
Referencing the eyelid margin shape functions to the center of a contact lens worn on an eye (i.e., such that the origin of the axes is at the center of the contact lens) rather than the center of the cornea.
Different techniques for combining eyelid shape data from different images, whereby they may be combined by taking a mean or median of the function coefficients, an average of the function value over certain areas, or averaging a ‘slope/gradient’ function of surface shapes generated from the eyelid shape data.

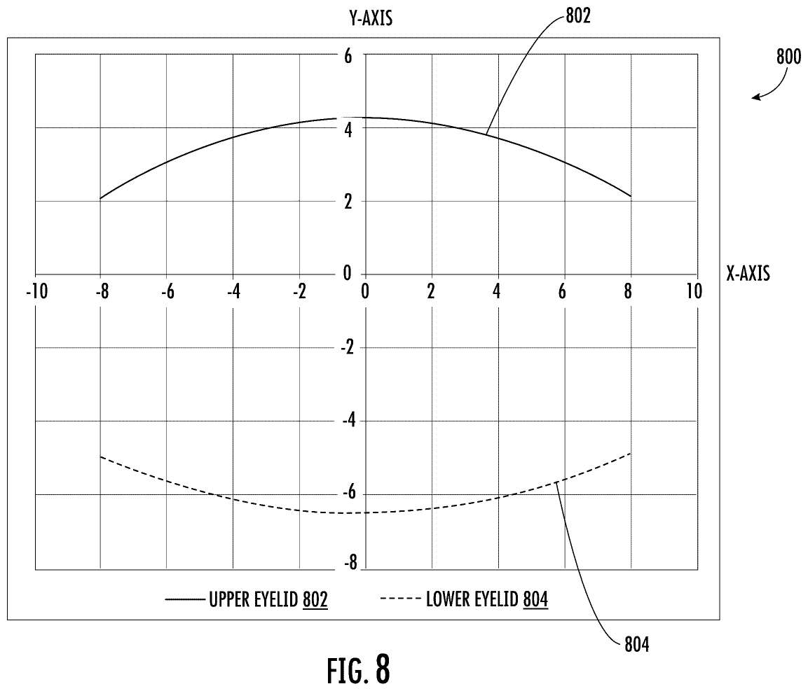

In an example, separately for the upper and lower eyelids, an average target eyelid margin shape was obtained by taking the median of all polynomials at each millimeter interval along the X-axis in the plot 700 in FIG. 7. FIG. 8 illustrates a plot 800 of upper and lower eyelid shape data 802, 804 separately for respective upper and lower eyelids, showing an average eyelid margin shape was obtained by taking the median of all polynomials at each millimeter interval along the X-axis. At each millimeter interval on the X-axis, the Y-axis value was determined by taking the median of all Y-axis values for the upper eyelid polynomials. A similar process was followed for the lower eyelid.

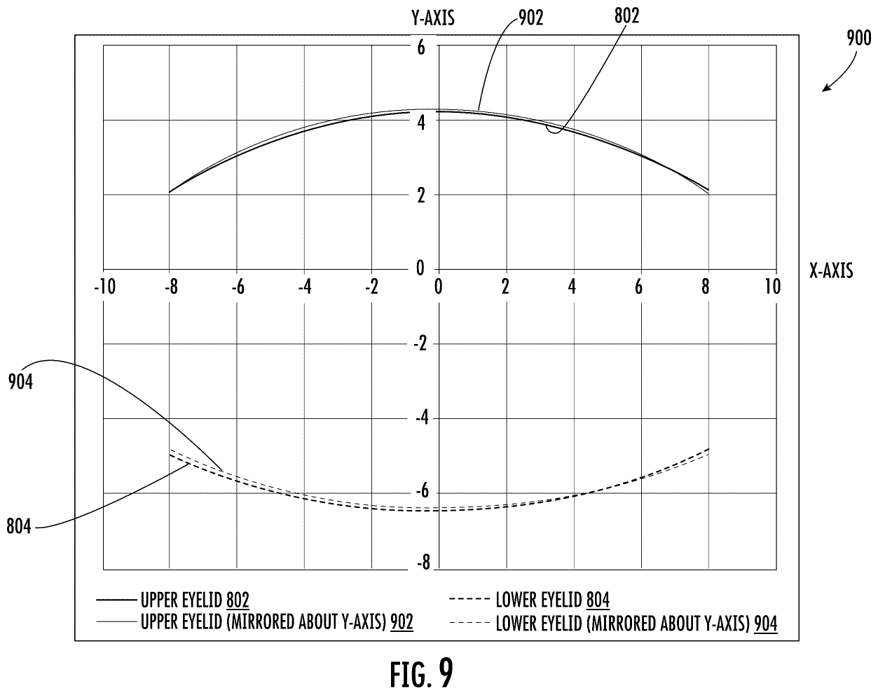

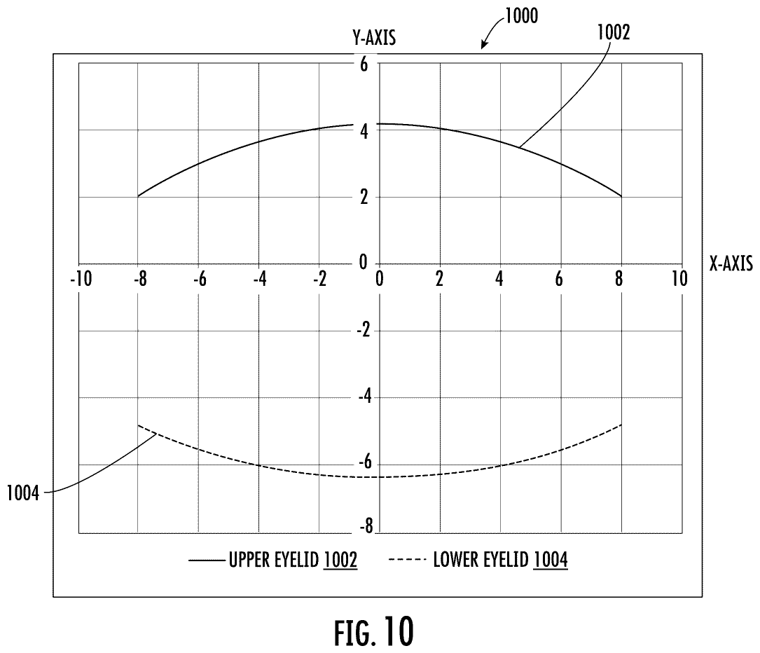

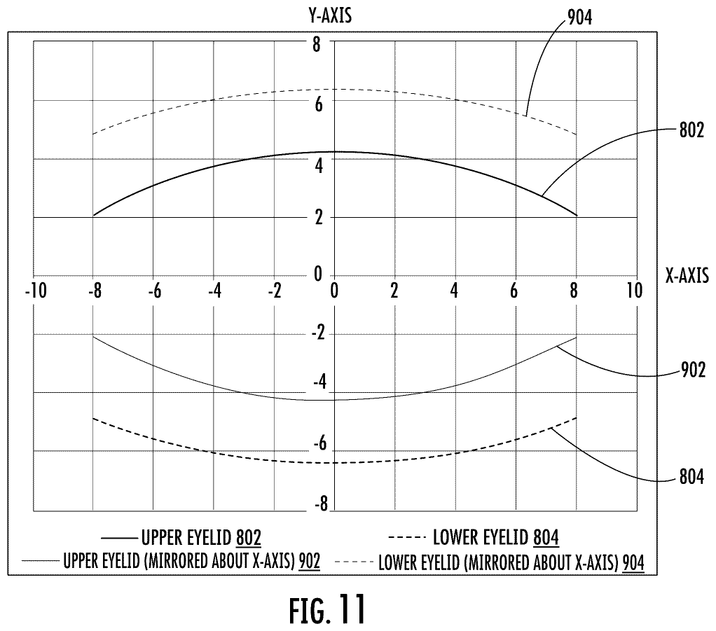

So that the final lens design may be left-right symmetrical, the data was “flipped” left-right about the Y-axis. FIG. 9 is a plot 900 that shows the left-right “flipped” upper and lower eyelid shape data 902, 904 and “non-flipped” upper and lower eyelid shape data 802, 804 plotted together on the same axes of upper and lower eyelids. The “flipped” and “non-flipped” data were then averaged together by taking the mean of the “flipped” and “non-flipped” Y-axis values at each position. The resultant “averaged” data is therefore symmetrical about the Y-axis. In this regard, FIG. 10 is a plot 1000 that shows the average 1002, 1004 of the “flipped” upper and lower eyelid shape data 902, 904 and “non-flipped” upper and lower eyelid shape data 802, 804 in FIG. 9, whereby the mean of the Y-axis values for each was taken at each millimeter interval. For example, to ensure the final design is top-bottom symmetrical about the X-axis, the eyelid shape data was again flipped, this time about the X-axis. FIG. 11 is a plot 1100 that shows the upper and lower “flipped” eyelid shape data 902, 904 and upper and lower “non-flipped” eyelid shape data 802, 804 plotted both together on the same axes.

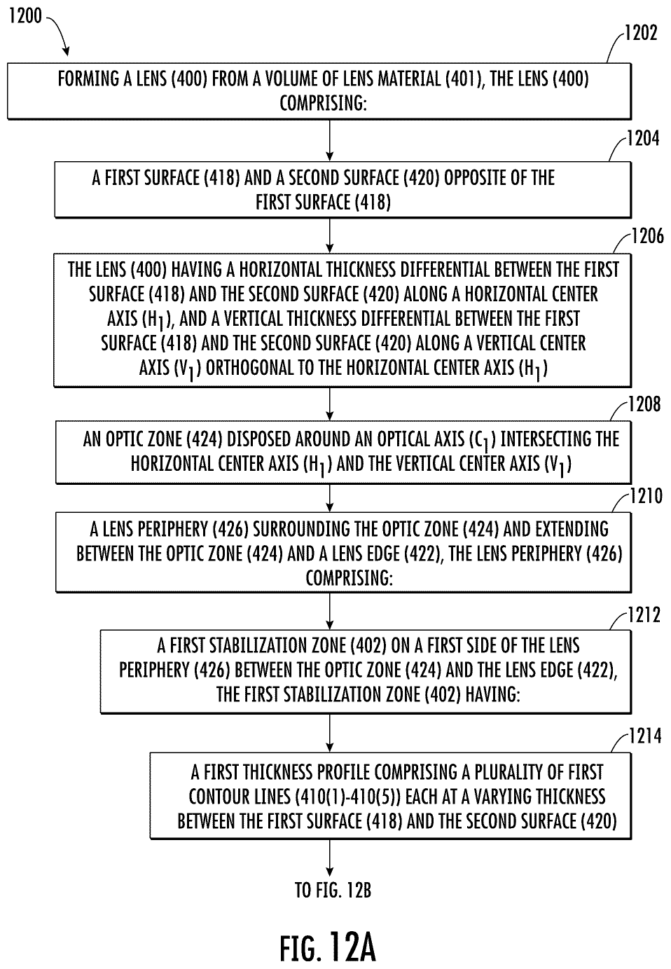

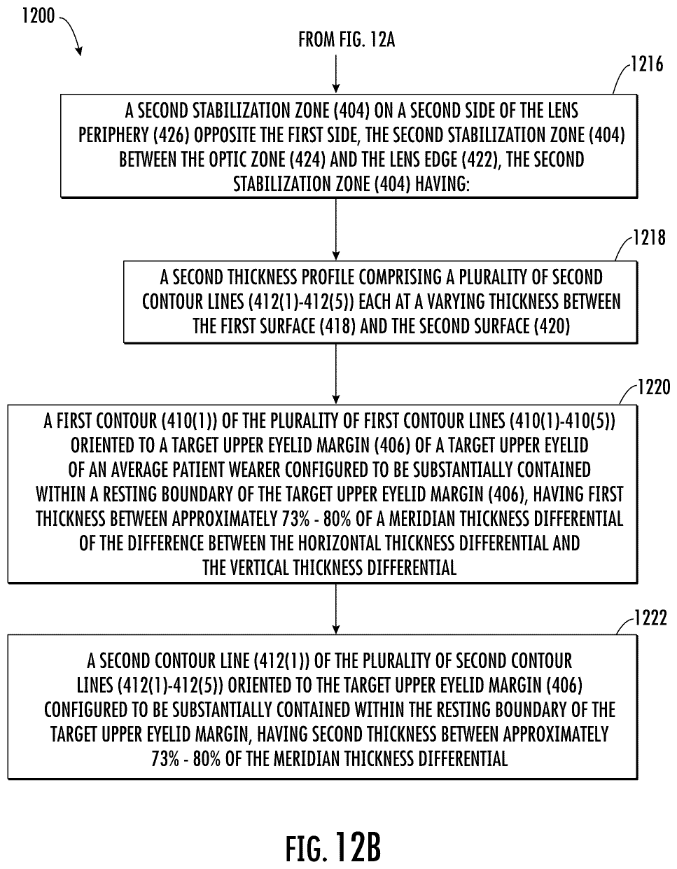

FIGS. 12A and 12B are a flowchart illustrating an exemplary process 1200 of designing a toric contact lens that has stabilization zones each having a varying thickness on each side of the optic zone of the lens about the vertical meridian, wherein the stabilization zones include active zones with contour lines oriented to a target eyelid margin shape(s) of a target eyelid(s) of an average patient wearer or improved stabilization in wearers with an asymmetric eyelid(s). Such a toric contact lens can include but is not limited to, the toric contact lens 400 in FIGS. 4A and 4B. The process 1200 in FIGS. 12A and 12B is discussed in regard to the toric contact lens 400 in FIG. 12 as an example but note that such is not limiting.

In this regard, as shown in FIG. 12A, a first step in the process 1200 can be forming a lens 400 from a volume of lens material 401 (block 1202 in FIG. 12A). The lens 400 can include a first surface 418 and a second surface 420 opposite of the first surface 418 (block 1204 in FIG. 12A). The lens 400 has a horizontal thickness differential between the first surface 418 and the second surface 420 along a horizontal center axis H₁, and a vertical thickness differential between the first surface 418 and the second surface 420 along a vertical center axis V₁ orthogonal to the horizontal center axis H₁ (block 1206 in FIG. 12A). The lens 400 has an optic zone 424 disposed around an optical axis C₁ intersecting the horizontal center axis H₁ and the vertical center axis V₁ (block 1208 in FIG. 12A). The lens 400 has a lens periphery 426 surrounding the optic zone 424 and extending between the optic zone 424 and a lens edge 422 (block 1210 in FIG. 12A). The lens periphery 426 includes a first stabilization zone 402 on a first side of the lens periphery 426 between the optic zone 424 and the lens edge 422 (block 1212 in FIG. 12A). The first stabilization zone 402 has a first thickness profile comprising a plurality of first contour lines 410(1)-410(5) each at a varying thickness between the first surface 418 and the second surface 420 (block 1214 in FIG. 12A).

As shown in FIG. 12B, the lens 400 also has a second stabilization zone 404 on a second side of the lens periphery 426 opposite the first side, the second stabilization zone 404 between the optic zone 424 and the lens edge 422 (block 1216 in FIG. 12B). The second stabilization zone 404 has a second thickness profile comprising a plurality of second contour lines 412(1)-412(5) each at a varying thickness between the first surface 418 and the second surface 420 (block 1218 in FIG. 12B). A first contour line 410(1) of the plurality of first contour lines 410(1)-410(5) oriented to a shape of a target upper eyelid margin 406 of a target upper eyelid of an average patient wearer configured to be substantially contained within a target resting boundary of the target upper eyelid margin 406, having first thickness between approximately 73%-80% of a meridian thickness differential of the difference between the horizontal thickness differential and the vertical thickness differential (block 1220 in FIG. 12B). A second contour line 412(1) of the plurality of second contour lines 412(1)-412(5) oriented to the shape of the target upper eyelid margin 406 configured to be substantially contained within the target resting boundary of the target upper eyelid margin, having second thickness between approximately 73%-80% of the meridian thickness differential (block 1222 in FIG. 12B).

Note that the aspects described above are in regard to exemplary contact lens systems, contact lens pairs, and individual contact lenses, but not that such examples are not limited to contact lenses but could be applied to any type of lenses and related lens systems and pairs.

It is important to note that the lens designs of the present disclosure may be incorporated into any number of different contact lenses formed from any number of materials. Specifically, the lens design of the present disclosure may be utilized in any of the contact lenses described herein, including, but not limited to, daily wear soft contact lenses, rigid gas-permeable contact lenses, bifocal contact lenses, toric contact lenses, and hybrid contact lenses. In addition, although the disclosure is described with respect to contact lenses, it is important to note that the concept of the present disclosure may be utilized in spectacle lenses, intraocular lenses, corneal inlays, and onlays.

It is to be understood that the disclosure is not to be limited to the specific aspects disclosed and that modifications and other aspects are intended to be included within the scope of the appended claims and their equivalents. Although specific terms are employed herein, they are used in a generic and descriptive sense only and not for purposes of limitation. Upon reading the following description in light of the accompanying drawing figures, those skilled in the art will understand the concepts of the disclosure and will recognize applications of these concepts not particularly addressed herein. The aspects set forth below represent the necessary information to enable those skilled in the art to practice the disclosure and illustrate the best mode of practicing the disclosure. It should be understood that these concepts and applications fall within the scope of the disclosure and the accompanying claims. Many modifications and other embodiments of the disclosure set forth herein will come to mind to one skilled in the art to which the disclosure pertains, having the benefit of the teachings presented in the foregoing descriptions and the associated drawings. Although shown and described in what is believed to be the most practical and specific aspects disclosed, modifications and other aspects are intended to be included within the scope of the appended claims. It is apparent that departures from specific designs and methods described and shown will suggest themselves to those skilled in the art and may be used without departing from the spirit and scope of the disclosure.

What is claimed is:

1. A toric contact lens, comprising:
a first surface and a second surface opposite of the first surface;
the lens having a horizontal thickness differential between the first surface and the second surface along a horizontal center axis, and a vertical thickness differential between the first surface and the second surface along a vertical center axis orthogonal to the horizontal center axis;
an optic zone disposed around an optical axis intersecting the horizontal center axis and the vertical center axis; and
a lens periphery surrounding the optic zone and extending between the optic zone and a lens edge, the lens periphery comprising:
a first stabilization zone on a first side of the lens periphery between the optic zone and the lens edge, the first stabilization zone having:
a first thickness profile comprising a plurality of first contour lines each at a varying thickness between the first surface and the second surface; and
a second stabilization zone on a second side of the lens periphery opposite the first side, the second stabilization zone between the optic zone and the lens edge, the second stabilization zone having:
a second thickness profile comprising a plurality of second contour lines each at a varying thickness between the first surface and the second surface; and
wherein:
a first contour line of the plurality of first contour lines oriented to a target upper eyelid margin shape of a target upper eyelid of an average patient wearer configured to be substantially contained within a resting boundary of the target upper eyelid margin, having first thickness between approximately 73%-80% of a meridian thickness differential of the difference between the horizontal thickness differential and the vertical thickness differential; and
a second contour line of the plurality of second contour lines oriented to the target upper eyelid margin shape configured to be substantially contained within the resting boundary of the target upper eyelid margin, having second thickness between approximately 73%-80% of the meridian thickness differential.

2. The contact lens of claim 1, wherein the target upper eyelid margin shape is asymmetric about the vertical center axis.

3. The contact lens of claim 1, wherein:
the first stabilization zone does not intersect the horizontal center axis; and
the second stabilization zone does not intersect the horizontal center axis.

4. The contact lens of claim 1, wherein:
the first stabilization zone and the second stabilization zone are symmetrical to each other about the horizontal center axis.

5. The contact lens of claim 1, wherein:
the first stabilization zone comprises a first active zone intersecting the plurality of first contour lines, the first active zone configured to intersect with an upper eyelid margin of a patient wearer; and
the second stabilization zone comprises a second active zone intersecting the plurality of second contour lines, the second active zone configured to intersect with the upper eyelid margin of the patient wearer.

6. The contact lens of claim 5, wherein:
the first active zone having a first thickness gradient across the plurality of first contour lines; and
the second active zone having a second thickness gradient across the plurality of second contour lines.

7. The contact lens of claim 6, wherein:
the first thickness gradient of the first active zone is in a direction substantially orthogonal to the target upper eyelid margin shape; and
a second thickness gradient of the first stabilization zone is in a direction substantially orthogonal to the target upper eyelid margin shape.

8. The contact lens of claim 5, wherein:
the first contour line in the first active zone is substantially parallel to the target upper eyelid margin shape; and
the second contour line in the second active zone is substantially parallel to the target upper eyelid margin shape.

9. The contact lens of claim 5, wherein:
each of the plurality of first contour lines in the first active zone is substantially parallel to the target upper eyelid margin shape; and
each of the plurality of second contour lines in the second active zone is substantially parallel to the target upper eyelid margin shape.

10. The contact lens of claim 5, wherein:
each of the plurality of first contour lines in the first active zone is substantially not concentric with the lens edge; and
each of the plurality of second contour lines in the second active zone is substantially not concentric with the lens edge.

11. The contact lens of claim 5, wherein:
each of the plurality of first contour lines outside the first active zone is substantially not concentric with the lens edge; and
each of the plurality of second contour lines outside the second active zone is substantially not concentric with the lens edge.

12. The contact lens of claim 6, wherein:
the first active zone and the second active zone are symmetrical to each other about the vertical center axis.

13. The contact lens of claim 12, wherein:
the first stabilization zone further comprises a third active zone having the first thickness gradient across the plurality of first contour lines;
the second stabilization zone further comprises a fourth active zone having the second thickness gradient across the plurality of second contour lines;
the first active zone and the third active zone are symmetrical to each other about the horizontal center axis; and
the second active zone and the fourth active zone are symmetrical to each other about the horizontal center axis.

14. The contact lens of claim 1, wherein:
a third contour line of the plurality of first contour lines oriented to a target lower eyelid margin shape of a target lower eyelid of an average patient wearer configured to be substantially contained within a resting boundary of the target lower eyelid margin, having first thickness between approximately 73%-80% of a meridian thickness differential of the difference between the horizontal thickness differential and the vertical thickness differential; and
a fourth contour line of the plurality of second contour lines oriented to the target lower eyelid margin shape configured to be substantially contained within the resting boundary of the target lower eyelid margin, having second thickness between approximately 73%-80% of the meridian thickness differential.

15. The contact lens of claim 1, wherein:
the first thickness is approximately 77% of the meridian thickness differential; and
the second thickness is approximately 77% of the meridian thickness differential.

16. The contact lens of claim 1, wherein:
the first contour line defines 0.23 millimeter (mm) thickness between the first surface and the second surface of the lens; and
the second contour line defines 0.23 mm thickness between the first surface and the second surface of the lens.

17. The contact lens of claim 1, wherein:
the first thickness profile varies from 0.2 millimeters (mm) thickness to 0.365 mm thickness between the first surface and the second surface of the lens; and
the second thickness profile varies from 0.2 mm thickness to 0.365 mm thickness between the first surface and the second surface of the lens.

18. The contact lens of claim 1, wherein:
the first thickness profile has a first maximum thickness between the first surface and the second surface of the lens of 0.365 millimeters (mm); and
the second thickness profile has a second maximum thickness between the first surface and the second surface of the lens of 0.365 mm.

19. The contact lens of claim 1, further comprising a thin zone is contained in an inferior region and a superior region of the lens outside the first stabilization zone and outside the second stabilization zone.

20. The contact lens of claim 18, wherein:
the first thickness profile varies from 0.2 millimeters (mm) thickness to 0.365 mm thickness between the first surface and the second surface of the lens;
the second thickness profile varies from 0.2 mm thickness to 0.365 mm thickness between the first surface and the second surface of the lens; and
the thin zone varies has a third maximum thickness of 0.2 millimeters (mm).

21. The contact lens of claim 1, wherein the target upper eyelid margin shape is derived from data from one or more images of one or more eyelid profiles of patients.

22. A method of fabricating a toric contact lens according to the toric contact lens of claim 1, comprising:
forming a lens from a volume of lens material, the lens comprising:
a first surface and a second surface opposite of the first surface;
the lens having a horizontal thickness differential between the first surface and the second surface along a horizontal center axis, and a vertical thickness differential between the first surface and the second surface along a vertical center axis orthogonal to the horizontal center axis;
an optic zone disposed around an optical axis intersecting the horizontal center axis and the vertical center axis; and
a lens periphery surrounding the optic zone and extending between the optic zone and a lens edge, the lens periphery comprising:
a first stabilization zone on a first side of the lens periphery between the optic zone and the lens edge, the first stabilization zone having:
a first thickness profile comprising a plurality of first contour lines each at a varying thickness between the first surface and the second surface; and
a second stabilization zone on a second side of the lens periphery opposite the first side, the second stabilization zone between the optic zone and the lens edge, the second stabilization zone having:
a second thickness profile comprising a plurality of second contour lines each at a varying thickness between the first surface and the second surface; and
wherein:
a first contour line of the plurality of first contour lines oriented to a target upper eyelid margin shape of a target upper eyelid of an average patient wearer configured to be substantially contained within a resting boundary of the target upper eyelid margin, having first thickness between approximately 73%-80% of a meridian thickness differential of the difference between the horizontal thickness differential and the vertical thickness differential; and
a second contour line of the plurality of second contour lines oriented to the target upper eyelid margin shape configured to be substantially contained within the resting boundary of the target upper eyelid margin, having second thickness between approximately 73%-80% of the meridian thickness differential.
